(19) United States
(12) Patent Application Publication
(10) Pub. No.: US 2017/0250981 A1
(43) Pub. Date: Aug. 31, 2017

(54) Small Form Factor Wireless Communication Device and Method

(71) Applicant: MAXWELL FOREST PTY LTD, Darlinghurst, New South Wales (AU)

(72) Inventors: Matthew Charles Denton, Bronte, New South Wales (AU); Anthony Mark Schofield, Campbell, Canberra, ACT (AU)

(21) Appl. No.: 15/518,734

(22) PCT Filed: Oct. 12, 2015
(86) PCT No.: PCT/AU2015/050619

§ 371 Date: Apr. 12, 2017

Related U.S. Application Data
(60) Provisional application No. 62/063,321, filed on Oct. 13, 2014.

(51) Int. Cl. H04L 29/06; H04W 12/08; G06Q 20/42; H04W 12/06

(52) U.S. Cl. CPC H04L 63/0853; H04W 12/06; H04W 12/08; H04L 63/10; G06Q 20/42

(57) ABSTRACT

Disclosed herein is a small form factor device for selectively communicating an authorisation signal. The small form factor device comprises a processor configured to process force signals received from a force sensor to determine the occurrence of an authorisation gesture. If an authorisation gesture is determined to have occurred and light is detected by a light sensor of the device, the processor further causes a wireless communications module of the device to transmit an authorisation signal.

### FIELD OF THE INVENTION

The present disclosure relates to a small form factor wireless communication device and methods for use in security and/or authentication applications.

### BACKGROUND OF THE INVENTION

Two often competing concerns in today's society are security and convenience.

People are increasingly looking to ways of increasing security—for example in terms of securing physical possessions, securing personal data, securing electronic transactions/communications, and even securing their identity.

At the same time, however, people are increasingly looking for convenience. As a generalisation, people do not generally want to carry additional bulky items, to remember passwords, or (often) even to have to enter passwords, despite the fact that such things can increase security.

Electronic devices can be used to increase security and convenience, but in order to counter the general aversion people have to carrying additional items such devices must be small. Small devices, however, carry small batteries which either drain quickly and/or require relatively frequent recharging—both of which compromise the convenience to end users.

### SUMMARY OF THE INVENTION

Described herein is a small form factor device for selectively communicating an authorisation signal, the small form factor device comprising: a power source; a force sensor for sensing forces applied to the small form factor device and generating force signals based thereon; a light sensor for sensing light; a wireless communications module powered by the power source, and a processor powered by the power source, wherein the processor is configured to: process force signals received from the force sensor to determine the occurrence of an authorisation gesture, and if an authorisation gesture is determined to have occurred and light is detected by the light sensor, to cause the wireless communications module to transmit the authorisation signal.

If an authorisation gesture is determined to have occurred and light is not detected by the light sensor the processor may be configured not to cause the wireless communications module to transmit the authorisation signal.

If an authorisation gesture is determined to have occurred and light is not detected by the light sensor the processor may be configured to: determine the occurrence of an override event; and if an override event is determined to have occurred, to cause the wireless communications module to transmit the authorisation signal.

Detection of one or more force signals corresponding to an override gesture may be an override event.

The override gesture may be a gesture performed with or on the small form factor device and selected from a group comprising: a single tap gesture; a double tap gesture; a multi tap gesture.

The small form factor device may comprise a user input, and activation of the user input may be an override event.

The small form factor device may have a credit card type form factor.

The small form factor device may have an ISO 7810 ID-1 compliant form factor.

The force sensor may be a piezoelectric transducer. The force sensor may be an accelerometer.

The communication module may be a Bluetooth communication module.

The authorisation gesture may be a gesture performed with or on the small form factor device and be selected from a group comprising: a single tap gesture; a double tap gesture; a multi tap gesture.

Also described herein is a computer-implemented method for operating a small form factor device to selectively communicate an authorisation signal, the computer-implemented method comprising: receiving, from a force sensor, force signals; determining, using a light sensor, whether or not light is detected; processing, by a computer processing unit, the force signals to determine the occurrence of an authorisation gesture; and if an authorisation gesture is determined to have occurred and light is determined to be detected, transmitting an authorisation signal.

If an authorisation gesture is determined to have occurred and light is not detected the method may comprise not transmitting the authorisation signal.

If an authorisation gesture is determined to have occurred and light is not detected the method may further comprise: determining the occurrence of an override event; and if an override event is determined to have occurred, operating the wireless communications module to communicate the authorisation signal.

Receiving one or more force signals corresponding to an override gesture may be an override event.

The override gesture may be a gesture made with or on the small form factor device selected from a group comprising: a single tap gesture; a double tap gesture; a multi tap gesture.

Activation of a user input may be an override event.

The small form factor device may have a credit card type form factor.

The small form factor device may have an ISO 7810 ID-1 compliant form factor.

The force sensor may be a piezoelectric transducer. The force sensor may be an accelerometer.

The authorisation signal may be transmitted via a Bluetooth communication module.

The authorisation gesture may be a gesture performed with or on the small form factor device and be selected from a group comprising: a single tap gesture; a double tap gesture; a multi tap gesture.

### BRIEF DESCRIPTION OF THE DRAWINGS

Illustrative embodiments of various aspects of the present description will now be described by way of non-limiting example only, with reference to the accompanying drawings. In the drawings:

FIG. 1 is a block diagram of a small form factor wireless communication device in accordance with one embodiment.

FIG. 2 is a block diagram of a computer processing system in accordance with an embodiment.

FIG. 3 is a flowchart illustrating operations of a small form factor device in accordance with an embodiment.

FIG. 4 is a flowchart illustrating operations of a small form factor device in accordance with an embodiment.

FIG. 5 is a flowchart illustrating operations of a small form factor device in accordance with an embodiment.

Where possible, the same reference numerals have been used in the figures to represent the same or like features.

### DETAILED DESCRIPTION OF THE EMBODIMENTS

Embodiments described herein generally relate to a small form factor wireless communication device, the configuration of such a device, and the operation of such a device in conjunction with a computer processing system in an authorisation process.

Initially, a small form factor device and a computer processing system will be described. Following this, computer-implemented methods for operating the small form factor device in authorisation processes will be described.

### Small Form Factor Device

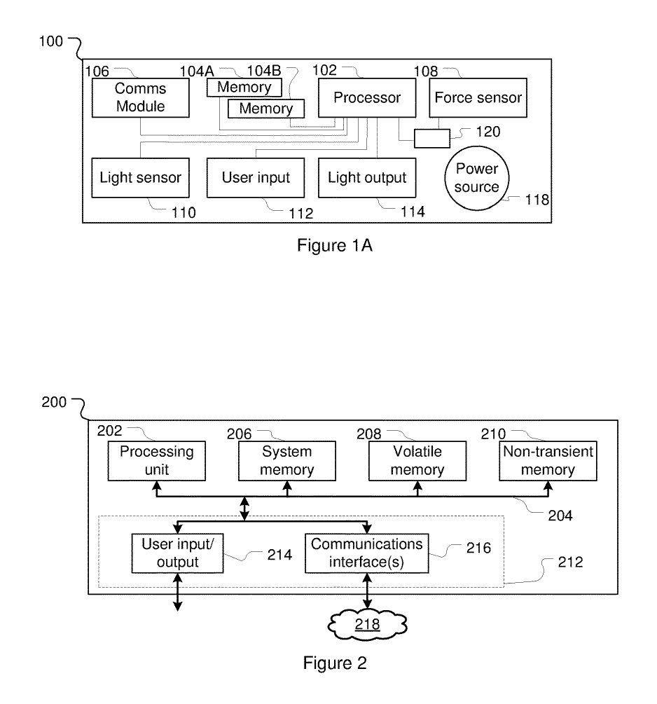

FIG. 1 provides a block diagram of a small form factor device 100 in accordance with an embodiment.

As used herein, “form factor” refers to the physical dimensions of a device. Furthermore, the phrase “small form factor” is intended to indicate a form factor of an object or device that is small enough to be carried conveniently by a user. Without wishing to be limited by precise dimensions, examples of small form factor devices in this context include credit card shaped/sized devices, key-fob sized devices, token devices and the like. By way of contrasting example, a mobile phone sized device would not, in this context, be considered to have a small form factor. However, in other embodiments, the device 100 may be a larger form factor device.

In one specific embodiment, the small form factor device 100 has an ISO 7810 ID-1 compliant form factor with dimensions of 85.6 mm×53.98 mm×0.76 mm thickness. ISO 7810 ID-1 cards are commonly used as payment cards (e.g. credit and debit cards).

In other embodiments the small form factor device 100 has, more generally, a credit-card type form factor. As used herein, a credit card type form factor refers to a form factor having the general shape and size of a credit card but without necessarily having the precise dimensions of an ISO 7810 ID-1 compliant card. A credit card type form factor may have zero or more dimensions as per an ISO 7810 ID-1 compliant form factor and one or more dimensions that are smaller or larger than an ISO compliant form factor. For example, a credit card type form factor may have: the length of an ISO compliant form factor but a different width and different thickness; the width of an ISO compliant form factor but a different length and different thickness; the thickness of an ISO compliant form factor but a different length and width; the length and width of an ISO compliant form factor but a different thickness; the length and thickness of an ISO compliant form factor but a different width; the width and thickness of an ISO compliant form factor but a different length.

Whether of a credit card type form factor generally, or an ISO 7810 ID-1 compliant form factor specifically, a device of these form factors can, typically, fit within a card slot of a wallet/card holder or the like.

Regardless of the specific form factor, device 100 generally comprises a processor 102, memory 104 for storing instructions executable by the processor 102 and data, and a wireless communication module 106 for enabling wireless communications with other devices (e.g., sending messages to other devices and receiving messages from other devices). In one embodiment the processor 102, memory 104 (which comprises both non-transient memory 104A (e.g., flash memory) and volatile memory 104B (e.g., RAM), and communication module 106 are provided in an integrated microcontroller unit (MCU) such as the CC2541 or CC2540 manufactured by Texas Instruments. In one embodiment, communication module in this case is a Bluetooth wireless communications module compliant with Bluetooth version 4.0/4.1 (also referred to as Bluetooth Low Energy (BLE)).

Device 100 also comprises a force sensor 108. As used herein, the term “force sensor” is used to generally describe devices/components that either sense forces (e.g. impact, pressure, compression, twisting/bending and the like) or the result of forces (e.g. acceleration) and output force signals in response thereto. In one embodiment, force sensor 108 is a piezoelectric transducer/sensor, such as a 7BB-20-6L0 piezoelectric transducer manufactured by Murata. The piezoelectric transducer outputs a voltage in response to a dynamic strain—for example in response to the device 100 being tapped on a surface/object, bent, compressed, or twisted. Use of a piezoelectric transducer has the advantage of detecting/signalling the occurrence of force without drawing power from the device power source 118.

In one embodiment output from the piezoelectric force sensor 108 passes through a high-pass filter 120. Generally speaking, by using a high-pass filter voltages generated by the piezoelectric transducer in response to small forces applied to the small form factor device 100 are filtered out and do not reach the processor 102 (or, therefore, require processing by the processor 102 and the consumption of power that would be associated therewith). More specifically, the high pass filter 120 attenuates/reduces the signal at certain frequencies (in the present embodiment a −3 dB attenuation at 100 Hz) and those around it. The filter (or a delay element thereof) also serves to gather the signal for a particular time constant (in the present embodiment 10 ms) before the signal is sent to the processor 102. This ensures that certain inputs can be filtered out. In addition, the high pass filter puts a voltage limiting resistor in line with the processor 102 which reduces the potential of damage to the processor input pin from high voltages generated by the piezoelectric transducer.

Alternative force sensors may, of course be used, for example one or more accelerometers (such as the ADXL362 accelerometer manufactured by Analog Devices).

Device 100 further comprises a light sensor 110 for detecting light. Generally speaking, the light sensor 110 may be any device/component that outputs a signal in response to being exposed to light. This signal is received by the processor 102 enabling the processor 102 to determine whether or not light is detected. By way of example, light sensor 110 may be a phototransistor such as a T1070P phototransistor manufactured by Vishay.

In certain embodiments device 100 further comprises a user input 112 operable by a user to interact with the small form factor device 100. The user input 112 may be a simple push-button input which, on activation by a user, sends a signal to the processor 102.

In certain embodiments device 100 further comprises a light output 114. In this case light output 114 is controlled by the processor 102 in order to output visual signals to a user of the device 100. By way of example, light output 114 may be a LED, such as a 16-219A/S2C-AP1Q2/3T LED manufactured by Everlight.

The small form factor device 100 also comprises a power source 118. The power source 118 is connected to and powers those components the device 100 that require power (connections not indicated in FIG. 1 for clarity)—for example, the MCU (i.e. the processor 102, memory 104, and communications module 106), and (where included) light output 114. The voltage supplied by the power source 118 may exceed the voltage required by the MCU. In this case a DC-DC converter is used in order to step down the voltage of the power source 118. In one embodiment power source 118 is a battery, such as a LiMn battery (for example manufactured by FDK). In some embodiments the power source 118 may comprise a rechargeable battery, either as the sole power source or in conjunction with a non-rechargeable battery. In this case the small form factor device 100 is also provided with contact points (not depicted) for connecting the small form factor device 100 to a charger to charge the rechargeable battery.

Depending on the particular components uses other components may or may not require power. For example, where a piezoelectric transducer is used for the force sensor 108 it will not require power/connection to the power source 118 to detect forces. Conversely, if an accelerometer is used for the force sensor 108 it will require power/connection to the power source 118.

Each of the components of the small form factor device 100 has a size that allows the components to be embedded in a small form factor device (e.g. a credit card type device, or an ISO 7810 ID-1 compliant device). Alternative components to those specifically mentioned are, of course, possible.

Where the small form factor device 100 is a credit card type device (either in a general sense or in an ISO compliant sense) manufacture of the device 100 may be a lamination process. For example, and generally speaking, device 100 may comprise multiple layers of materials encapsulated together into a credit card form factor. One encapsulation process uses of a room temperature resin encapsulant. The relevant components (e.g. electronic components) are provided in a wafer form positioned on a thin, flexible printed circuit board which forms a middle layer. This middle layer is then sandwiched between top and bottom card laminate surfaces to create the final assembly. Use of a room temperature resin encapsulant can have advantages over traditional hot lamination or injection moulding processes, both of which involve the application of heat and pressure which can be detrimental to electronic components.

As discussed in more detail below, the small form factor device 100 is configured (either by hardware configuration, firmware, and/or software stored in non-transient memory 104A and executed by processor 102) to communicate with other computer processing systems and devices via the communications module 106.

In one embodiment device 100 is a payment card—e.g. a bank card, Visa card, MasterCard, American Express card or the like. In this case the device 100 will also be provided with components to enable the device 100 to be used as a payment card—e.g. a magnetic stripe with relevant encoded data, an EMV chip (contact and/or contactless), or a combination thereof.

It will be appreciated that the functional components of device 100 may be provided in a variety of interconnected physical components. For example, and as per the embodiment described above, the processor 102, communications module 104, and memory 106 are a physically integrated component. In alternative embodiments these may be separate physical components. It will also be appreciated that alternative embodiments of device 100 may be provided with additional, alternative, and or fewer components. For example, in some embodiments a light output may not be provided, and in other embodiments multiple light outputs may be provided.

The components and features of device 100 could, of course, be provided in a larger form-factor device if desired.

### Computer Processing System

Device 100 is configured to communicate with a computer processing system. FIG. 2 provides a block diagram of a typical computer processing system 200.

The computer processing system 200 comprises a processing unit 202. The processing unit 202 may comprise a single computer-processing device (e.g. a central processing unit, graphics processing unit, or other computational device), or may comprise a plurality of computer processing devices. In some instances processing is performed solely by processing unit 202, however in other instances processing may also, or alternatively, be performed by remote processing devices accessible and useable (either in a shared or dedicated manner) by the system 200.

Through a communications bus 204 the processing unit 202 is in data communication with one or more machine-readable storage (memory) devices that store instructions and/or data for controlling operation of the processing system 200. In this instance system 200 comprises a system memory 206 (e.g. a BIOS), volatile memory 208 (e.g. random access memory such as one or more DRAM modules), and non-volatile/non-transient memory 210 (e.g. one or more hard disk or solid state drives).

System 200 also comprises one or more interfaces, indicated generally by 212, via which system 200 interfaces with various devices and/or networks. Generally speaking, other devices may be physically integrated with system 200, or may be physically separate. Where such devices are physically separate from system 200, connection between the device and system 200 may be via wired or wireless hardware and communication protocols, and may be direct or an indirect (e.g. networked) connections.

Wired connection with other devices/networks may be by any appropriate standard or proprietary hardware and connectivity protocols. For example, system 100 may be configured for wired connection with other devices/communications networks by one or more of: USB; FireWire; eSATA; Thunderbolt; Ethernet; Parallel; Serial; HDMI; DVI; VGA; AudioPort. Other wired connections are, of course, possible.

Wireless connection with other devices/networks may similarly be by any appropriate standard or proprietary hardware and communications protocols. For example, system 100 may be configured for wireless connection with other devices/communications networks using one or more of: infrared; Bluetooth (e.g. Bluetooth 4.0/4.1, also known as Bluetooth low energy); Wi-Fi; near field communications (NFC); Global System for Mobile Communications (GSM), Enhanced Data GSM Environment (EDGE), long term evolution (LTE), wideband code division multiple access (W-CDMA), code division multiple access (CDMA). Other wireless connections are, of course, possible.

Generally speaking, the devices to which system 200 connects—whether by wired or wireless means—allow data to be input into/received by system 200 for processing by the processing unit 202, and data to be output by system 200. Example devices are described below, however it will be appreciated that not all computer-processing systems will comprise all mentioned devices, and that additional and alternative devices to those mentioned may well be used.

For example, system 200 may comprise or connect to one or more input devices by which information/data is input into (received by) system 200. Such input devices may comprise physical buttons, alphanumeric input devices (e.g. keyboards), pointing devices (e.g. mice, track-pads and the like), touchscreens, touchscreen displays, microphones, accelerometers, proximity sensors, GPS devices and the like. System 200 may also comprise or connect to one or more output devices controlled by system 200 to output information. Such output devices may comprise devices such as indicators (e.g. LED, LCD or other lights), displays (e.g. CRT displays, LCD displays, LED displays, plasma displays, touch screen displays), audio output devices such as speakers, vibration modules, and other output devices. System 200 may also comprise or connect to devices which may act as both input and output devices, for example memory devices (hard drives, solid state drives, disk drives, compact flash cards, SD cards and the like) which system 200 can read data from and/or write data to, and touch-screen displays which can both display (output) data and receive touch signals (input).

System 200 may also connect to communications networks (e.g. the Internet, a local area network, a wide area network, a personal hotspot etc.) to communicate data to and receive data from networked devices, which may themselves be other computer processing systems.

It will be appreciated that system 200 may be any suitable computer processing system such as, by way of non-limiting example, a desktop computer, a laptop computer, a netbook computer, tablet computer, a smart phone, a Personal Digital Assistant (PDA), a cellular telephone, a web appliance. Typically, system 200 will comprise at least user input and output devices 214 and (if the system is to be networked) a communications interface 216 for communication with a network 218. The number and specific types of devices which system 200 comprises or connects to will depend on the particular type of system 200. For example, if system 200 is a desktop computer it will typically connect to physically separate devices such as (at least) a keyboard, a pointing device (e.g. mouse), a display device (e.g. a LCD display). Alternatively, if system 200 is a laptop computer it will typically comprise (in a physically integrated manner) a keyboard, pointing device, a display device, and an audio output device. Further alternatively, if system 200 is a tablet device or smartphone, it will typically comprise (in a physically integrated manner) a touchscreen display (providing both input means and display output means), an audio output device, and one or more physical buttons.

System 200 stores or has access to instructions and data which, when processed by the processing unit 202, configure system 200 to receive, process, and output data. Such instructions and data will typically comprise an operating system such as Microsoft Windows®, Apple OSX, Unix, Linux, Apple iOS, Android.

System 200 also stores or has access to instructions and data (i.e. software) which, when processed by the processing unit 202, configure system 200 to perform various computer-implemented processes/methods in accordance with embodiments (as described below). It will be appreciated that in some cases part or all of a given computer-implemented method will be performed by system 200 itself, while in other cases processing may be performed by other devices in data communication with system 200.

Instructions and data are stored on a non-transient machine-readable medium accessible to system 200. For example, instructions and data may be stored on non-transient memory 210. Instructions may be transmitted to/received by system 200 via a data signal in a transmission channel enabled (for example) by a wired or wireless network connection.

It will be appreciated that FIG. 2 does not illustrate all functional or physical components of a computer processing system. For example, no power supply or power supply interface has been depicted, however system 200 will carry a power supply or be configured for connection to a power supply (or both). It will also be appreciated that the particular type of computer processing system will determine the appropriate hardware and architecture, and alternative computer processing systems suitable for implementing aspects of the embodiments may have additional, alternative, or fewer components than those depicted, combine two or more components, and/or have a different configuration or arrangement of components.

### Authorisation Process

In one embodiment, the small form factor device 100 is used in conjunction with a computer processing system 200 in an authorisation process. The computer processing system 200 may be a portable computer processing system (e.g. a mobile phone), or may be any other suitable computer processing system (e.g. desktop computer, laptop computer, tablet computer or the like).

Generally speaking, the authorisation process involves the user operating the computer processing system 200 and reaching a point where authorisation is required. This may, for example, be where entry of a password is required to access functions/services, or for example, identification/authorisation is required. As one particular example, this may occur when a user is operating a web browser/e-commerce application on computer processing system 200 to purchase goods or services. This typically involves browsing through an online listing of available goods/services, selecting those of interest, and proceeding to a “checkout.” In order to complete the electronic transaction at checkout details of the user typically need to be entered (e.g. payment and/or shipping details). In this case the user can use the small form factor device 100 to send an authorisation signal to the computer processing system 200. The authorisation signal is then used by the computer processing system 200 either alone or in conjunction with other authorisation factors (e.g. user names, passwords and the like) to retrieve relevant details from memory (e.g. stored payment, shipping or other details) and use these to complete the transaction.

By way of example, PCT application PCT/IB2013/002032 filed on 16 Jul. 2013 and titled “Authorization of Transactions” (the contents of which are hereby incorporated by reference in their entirety) describes use of an “authentication device” in a transaction process. The small form factor device 100 can be used in a similar way. For example, in order to complete an electronic transaction on computer processing system 200 the computer processing system 200 may require an authorisation signal to be received from the small form factor device 100.

The small form factor device 100 is configured to send such an authorisation signal (via the communications module 106) on detection of a defined authorisation gesture. As described, in one embodiment the force sensor 108 is a piezoelectric transducer which generates a force signal (i.e. a voltage spike) on detection of a force. Provided the voltage generated by the transducer is of sufficient magnitude that it is not filtered out by the high pass filter 120, force signals from the force sensor 108 reach the processor 102 and are processed in order to determine whether they match any defined gestures.

Authorisation gesture definitions are stored in non-transient memory 104B. By way of example, different authorisation gestures may be defined as the receipt of one or more voltage spikes (caused by one or more taps on/with the device 100) within a defined time period. For example, a single tap gesture may be defined as the receipt of one and only one force signal (e.g. voltage spike) within a defined time period. A single tap gesture is then performed by a user tapping the device 100 on a surface/object (or tapping the device 100 with an object) once within the defined time period. A double tap gesture may be defined as the receipt of two force signals (or a single force signal with a profile indicating two voltage spikes) within a defined time period. More generally, a multi-tap gesture may be defined as predefined number of voltage spikes within a defined time period. The defined time period for one gesture may be the same or different to the defined time period for another gesture.

More complex authorisation gesture definitions may also be defined in terms of force signals and timings (essentially defining an authorisation gesture rhythm). One example of a more complex authorisation gesture definition may be a certain number of signals received in a first time period (e.g. three voltage spikes within ½ a second) followed by a certain number of signals received in second time period (e.g. two voltage spikes received in one second). This can be extended by defining further requirements (e.g. a further number of signals received in a third time period and so on). Generally speaking, the more complex the authorisation gesture the less likely it is to be performed inadvertently due to the device 100 being accidently bumped/jostled in a bag or wallet or the like. At the same time, though, users may find having to perform more complicated authorisation gestures inconvenient.

As noted, the small form factor device 100 is, in some embodiments, intended to be carried in a wallet or purse. Whilst being carried, it is possible that movement of the small form factor device 100 will inadvertently cause forces to be applied to the device 100. Such forces may result in force signals corresponding to a defined authorisation gesture to occur (causing the processor 102 to cause an authorisation signal to be communicated by the small form factor device 100). This is undesirable as operating the communications module 106 to communicate an authorisation signal when this is not intended by the user results in unnecessary consumption of power (recalling that battery life of the small form factor device 100 is a significant consideration).

In order to try and limit unnecessary power consumption, the small form factor device 100 of the present embodiment makes use of the light sensor 110 to determine a state of the small form factor device 100 and operates according to the determined state.

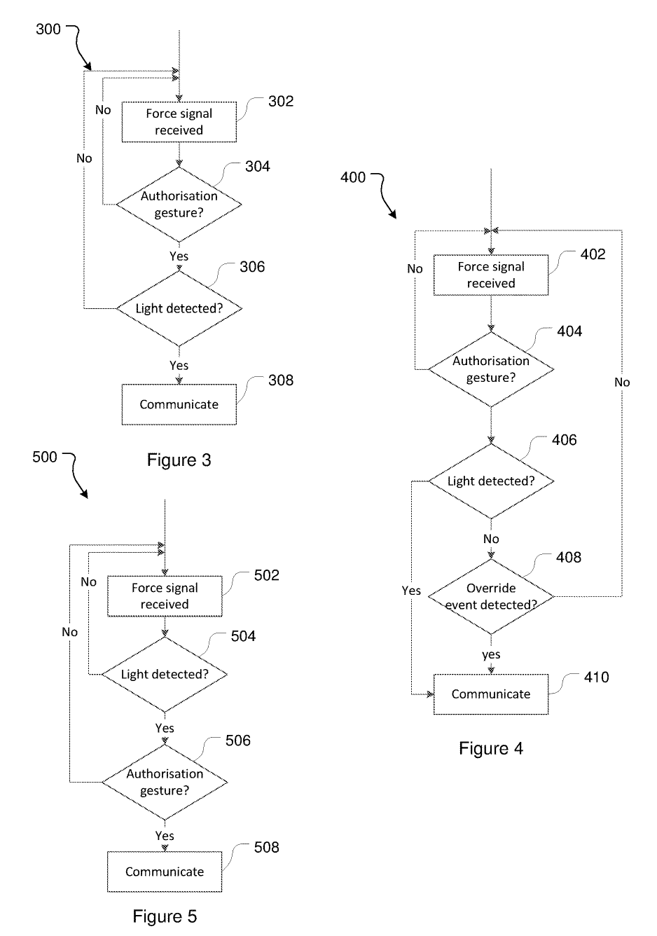

Referring to FIG. 3, operation 300 of the small form factor device 100 in accordance with an embodiment will be described.

At 302 a force signal is received by the processor 102. This occurs on a force being detected by the force sensor 108 which causes a force signal to be generated. Provided the force is of sufficient magnitude (and the voltage generated passes the high pass filter 120) the force signal is passed to (received by) the processor 102.

At 304 the processor 102 processes the force signal to determine whether or not the force signal corresponds to a defined authorisation gesture.

If the force signal does not correspond to a defined authorisation gesture, no further action is taken by the processor in respect of the force detected at 302.

At 306, if the force signal does correspond to an authorisation gesture, the processor 102 determines whether light is detected by the light sensor 110.

At 308, if light is detected, the processor 102 operates the communications module 106 to communicate the authorisation signal to the computer processing system 200. In this case the detection of light is treated as an indication that the small form factor device 100 is not in a wallet/bag or similar and, as such, there is a higher likelihood that the detected gesture was an intentional gesture by a user. This is on the basis that when a user intends to use the small form factor device 100 to transmit an authorisation signal the user will typically take the small form factor device 100 out of its housing (e.g. a wallet, purse, bag, card holder or other housing) in order to make the required gesture.

If light is not detected by the light sensor 110 no further action in respect of the force detected at 302 is taken. In this case the absence of light is treated as an indication that the small form factor device 100 is currently in a wallet/bag/similar and, as such, there is a low likelihood that the gesture was intentional (or, conversely, a greater likelihood that the gesture was unintentional, e.g. a product of the small form factor device being jostled around whilst being carried or suchlike). By not operating the communications module 106 to communicate the authorisation signal in this situation power is conserved.

FIG. 4 depicts operation 400 of the small form factor device 100 in accordance with an alternative embodiment.

As with operation 300 (of FIG. 3), operation 300 commences with a force signal being received 402 at the processor 102, determination of whether the force corresponds to an authorisation gesture 404, determination of whether light is or is not detected at 406, and (if light is detected at 406), operation of the communications module 106 to communicate the authorisation signal at 410.

If light is not detected at 406, however, in this embodiment the processor 102 is configured to wait for a predetermined override time period to determine whether an override event is detected (at 408). The predetermined override period may, for example 2 seconds (though could of course be any desired value—e.g. less than 1 second, 1 second, 3 seconds, 4 seconds, 5 seconds, more than 5 seconds). In one embodiment, the override event is an override gesture—e.g. a further tap gesture (that is received within the predetermined override period). An alternative override event could be the activation of the user input 112 (e.g. a long or short press of a button on the small form factor device 100).

If the override event is not detected within the predetermined override period, no further action is taken by the processor in respect of the force detected at 402.

At 410, if an override event is detected within the predetermined override period, however, the processor 102 operates the communications module 106 to communicate the authorisation signal.

By implementing an override event a user can operate the small form factor device 100 to communicate the authorisation signal even if light is not detected by the light sensor 110—i.e. by performing the initial gesture and causing the override event (e.g. performing the override gesture) within the predetermined override time period. This can be useful where a user does not want to have to remove the small form factor device 100 from a wallet or similar in order to communicate the authorisation signal. By requiring the additional override event, however, there is a greater likelihood that unintended activations will occur (the likelihood of the initial gesture and override event occurring unintentionally being less than the likelihood of the initial gesture alone occurring unintentionally).

For example, if the small form factor device 100 is housed in a wallet, the initial gesture is a tap gesture and the override gesture is also a tap gesture, the user can (effectively) perform a double tap gesture on their wallet in order to communicate the authorisation signal without having to remove the small form factor device from their wallet.

FIG. 5 depicts a further embodiment which is similar to the embodiment of FIG. 3, but instead of determining whether or not an authorisation gesture has occurred before detecting whether light is present the processor 102 is configured to determine whether or not light is present first (and only if light is present determine whether force signals correspond to defined authorisation gestures).

At 502 a force signal is received at the processor 102.

At 504 the processor 102 determines whether or not light is detected. If light is not detected no further action is taken in respect of the force signal received at 502.

At 506, if light is detected, processor 102 processes the force signal to determine whether or not the force signal corresponds to a defined authorisation gesture. If not no further action is taken in respect of the signal.

At 508, if the force signal does correspond to a defined authorisation gesture the processor 102 operates the communications module 106 to communicate the authorisation signal to computer processing system 200.

While the operations described above have been described with respect to detection of “a force” and processing of “a force signal”, it will be appreciated that these may in fact be multiple forces and a force signal may comprise multiple components. For example, if a defined authorisation signal is two voltage spikes in a determined time period, then the relevant authorisation gesture involves two forces applied to/with the device (e.g. a double tap with/on the device) and the force signal detected/processed by the processor 102 comprises two voltage spikes.

Further alternative embodiments are, of course, possible. For example, light sensor 110 may be an optocoupler providing a switch between the force sensor 108 and the processor 102. When light is detected by the optocoupler the switch is closed and signals from the force sensor 108 are conveyed to and processed by the processor 102, enabling the gesture detection functionality of the small form factor device 100. Conversely, when light is not detected by the optocoupler the switch is open preventing any signals generated by the force sensor 108 from being conveyed to the processor 102, disabling the gesture detection functionality of the small form factor device 100. In this embodiment, if light is not detected by the light sensor 110 the switch is open and no force signals will be sent to the processor (or, accordingly, cause power to be consumed in their processing). Conversely, if light is detected the switch is open and gestures will be received by the processor 102 and processed normally.

As will be appreciated, the small form factor device 100 may be configured to perform the operations described above in a variety of ways. For example, the small form factor device 100 may be configured to perform operations by software (i.e. computer readable instructions and data stored in a non-transient memory such as 104A) executed by processor 102. Alternatively, the small form factor device 100 may be configured to perform the operations described by virtue of its hardware configuration alone. Further alternatively, the small form factor device may be configured to perform the operations described by a combination of hardware and software configuration.

As used herein the terms “include” and “comprise” (and variations of those terms, such as “including”, “includes”, “comprising”, “comprises”, “comprised” and the like) are intended to be inclusive and are not intended to exclude further features, components, integers or steps.

It will be understood that the embodiments disclosed and defined in this specification extends to all alternative combinations of two or more of the individual features mentioned or evident from the text or drawings. All of these different combinations constitute various alternative aspects of the embodiments.

1. A device for selectively communicating an authorisation signal, the device comprising:
a power source;
a force sensor for sensing forces applied to the device and generating force signals based thereon;
a light sensor for sensing light;
a wireless communications module powered by the power source, and
a processor powered by the power source, wherein the processor is configured to:
process force signals received from the force sensor to determine the occurrence of an authorisation gesture,
determine if light is detected by the light sensor; and
if an authorisation gesture is determined to have occurred and light is determined to be detected by the light sensor, cause the wireless communications module to transmit an authorisation signal.

2. The device of claim 1, wherein if an authorisation gesture is determined to have occurred and light is not detected by the light sensor, the authorization signal is not transmitted.

3. The device of claim 1, wherein if an authorisation gesture is determined to have occurred and light is not detected by the light sensor the processor is configured to:
determine the occurrence of an override event; and
if an override event is determined to have occurred, to cause the wireless communications module to transmit the authorisation signal.

4. The device of claim 3, wherein detection of one or more force signals corresponding to an override gesture is an override event.

5. The device of claim 4, wherein the override gesture is a gesture performed with or on the device and selected from a group comprising: a single tap gesture; a double tap gesture; a multi tap gesture.

6. The device of claim 3, wherein the device comprises a user input, and activation of the user input is an override event.

7. The device of claim 1, wherein the device has a credit card type form factor.

8. The device of claim 1, wherein the small form factor device has an ISO 7810 ID-1 compliant form factor.

9. (canceled)

10. (canceled)

11. The device of claim 1, wherein the authorisation gesture is a gesture performed with or on the device and is selected from a group comprising: a single tap gesture; a double tap gesture; a multi tap gesture.

12. A computer-implemented method for operating a device to selectively communicate an authorisation signal, the computer-implemented method comprising:
receiving, from a force sensor, force signals;
determining whether or not light is detected by a light sensor;
processing, by a computer processing unit, the force signals to determine the occurrence of an authorisation gesture; and
if an authorisation gesture is determined to have occurred and light is determined to be detected by the light sensor, transmitting an authorisation signal.

13. The computer-implemented method of claim 12, wherein if an authorisation gesture is determined to have occurred and light is not detected, the authorisation signal is not transmitted.

14. The computer-implemented method of claim 12, wherein if an authorisation gesture is determined to have occurred and light is not detected the method further comprises:
determining the occurrence of an override event; and
if an override event is determined to have occurred, transmitting the authorisation signal.

15. The computer-implemented method of claim 14, wherein receiving one or more force signals corresponding to an override gesture is an override event.

16. The computer-implemented method of claim 15, wherein the override gesture is a gesture made with or on the device selected from a group comprising: a single tap gesture; a double tap gesture; a multi tap gesture.

17. The computer-implemented method of claim 14, wherein activation of a user input is an override event.

18. The computer-implemented method of claim 12, wherein the device has a credit card type form factor.

19. The computer-implemented method of claim 12, wherein the device has an ISO 7810 ID-1 compliant form factor.

20. (canceled)

21. (canceled)

22. The computer-implemented method of claim 12, wherein the authorisation gesture is a gesture performed with or on the device and is selected from a group comprising: a single tap gesture; a double tap gesture; a multi tap gesture.

23. The device of claim 1, wherein the device has a small form factor.

24. The computer-implemented method of claim 12, wherein the device has a small form factor.
